(19) United States
(12) Patent Application Publication
(10) Pub. No.: US 2013/0122194 A1
(43) Pub. Date: May 16, 2013

(54) OPTICAL FIBER MANUFACTURING METHOD

(71) Applicant: Furukawa Electric Co., Ltd., Tokyo (JP)

(72) Inventor: Keisuke Ui, Tokyo (JP)

(73) Assignee: FURUKAWA ELECTRIC CO., LTD., Tokyo (JP)

(21) Appl. No.: 13/735,514

(22) Filed: Jan. 7, 2013

Related U.S. Application Data
(63) Continuation of application No. PCT/JP2011/007081, filed on Dec. 19, 2011.

(30) Foreign Application Priority Data
Dec. 27, 2010 (JP) 2010-290272

(51) Int. Cl. B05D 5/06

(52) U.S. Cl. CPC B05D 5/06
USPC 427/163.2

(57) ABSTRACT

A manufacturing method of one embodiment of the present invention comprises the step of ejecting liquid resin through a resin supply hose connected to a containing tank to a coating device, and causing the coating device to apply the liquid resin to an optical fiber to form a coating layer. Before the step of forming the coating layer, this manufacturing method comprises the steps of: causing the liquid resin to be ejected through the resin supply hose to a cup which is different from the coating device, to measure an ejection amount of the liquid resin; and determining whether the measured ejection amount of the liquid resin is within an acceptable range or not. Then, the step of forming the coating layer is performed when it is determined, as a result, that the measured ejection amount of the liquid resin is within the acceptable range.

### CROSS-REFERENCES TO RELATED APPLICATIONS

This application is a continuation application of International Application No. PCT/JP2011/007081, filed Dec. 19, 2011, which claims the benefit of Japanese Patent Application No. 2010-290272, filed Dec. 27, 2010. The contents of the aforementioned applications are incorporated herein by reference in their entireties.

### BACKGROUND OF THE INVENTION

1. Field of the Invention

The present invention relates to an optical fiber manufacturing method.

2. Description of the Related Art

In an optical fiber manufacturing method, liquid resin is applied to a drawn optical fiber immediately after the drawing process to form a coating layer. In a typical method for the formation of the coating layer, resin is supplied from a resin tank to a coating device configured to coat an optical fiber, and an optical fiber is caused to pass inside this coating device to be coated with the liquid resin. In the step of forming the coating layer, a large change in the pressure of the resin in the coating device might cause problems such as making the coating layer uneven and entraining bubbles in the coating layer, in the interface between the coating layer and glass, or in the interface between the coating layers.

Various techniques have been considered to solve these problems to achieve optical fiber drawing capable of even coating without bubble entrainment.

For example, the following are known as such techniques: limitations on the properties of resin, such as a weight-average molecular weight of oligomers and the viscosity of resin (see Patent Document 1), the ratio of viscosity between primary and secondary coating layers (see Patent Document 2), and the difference in viscosity between a high-temperature layer and a low-temperature layer of applied resin (see Patent Document 3); and use of specific manufacturing conditions, such as the temperature of resin, the difference in temperature between glass and resin (see Patent Documents 4 and 5), a relational expression of a resin pressure, a viscosity, a drawing speed, and a fiber's outer diameter (see Patent Document 6).

Besides these, there are also known to give a certain feature to a manufacturing facility or device, such as a resin coating device (see Patent Document 7) and a coating coolant gas tower (see Patent Document 8).
[Patent Document 1] Japanese Patent Application Publication No. Hei 09-241341
[Patent Document 2] Japanese Patent Application Publication No. Hei 08-325041
[Patent Document 3] Japanese Patent Application Publication No. Hei 08-082725
[Patent Document 4] Japanese Patent Application Publication Nos. Hei 02-212338
[Patent Document 5] Japanese Patent Application Publication Hei 03-285846
[Patent Document 6] Japanese Patent Application Publication No. Hei 09-236732
[Patent Document 7] Japanese Patent Application Publication No. 2001-048597
[Patent Document 8] Japanese Patent Application Publication No. Hei 11-035344

### SUMMARY OF THE INVENTION

In the techniques described in above Patent Documents 1 to 6 which limit the properties of resin or which use specific manufacturing conditions, if the resin to be used or the manufacturing conditions to be employed are determined first, management thereafter is only to maintain those manufacturing conditions. Accordingly, if any trouble should occur, such as an overflow of resin from the coating device due to some state change, the drawing has to be paused. In addition, to merely maintain the determined manufacturing conditions cannot detect an external abnormality, such as entrainment of bubbles in the coating layer or unevenness of the coating layer, until the above-described trouble actually occurs. Consequently, a great number of faults may be produced.

The techniques described in Patent Documents 7 and 8 which give a certain feature to the facility or device also require a pause of the drawing when a trouble occurs due to a state change. Moreover, since an external abnormality cannot be detected until a trouble actually occurs, faults might be produced.

The present invention has been made in consideration of such problems, and has an objective of providing an optical fiber manufacturing method with which, in formation of a coating layer on an optical fiber, troubles including an external abnormality, such as bubble entrainment in the coating layer or unevenness of the coating layer, fiber breakage, decentering, dimensional variability, resin overflow, and the like can be prevented or reduced.

To achieve such an objective, the present invention is an optical fiber manufacturing method including a step of supplying liquid resin from a container configured to contain the liquid resin to a coating device by ejecting the liquid resin to the coating device through a supply passage connected to the container, and causing the coating device to apply the liquid resin to an optical fiber to form a coating layer on the optical fiber, comprising the steps of: causing, before the step of forming the coating layer, the liquid resin to be ejected through the supply passage to a vessel which is separate from the coating device, to measure an ejection amount of the liquid resin; and determining whether the measured ejection amount of the liquid resin is within an acceptable range or not, and wherein the step of forming the coating layer is performed when it is determined that the measured ejection amount of the liquid resin is within the acceptable range.

According to the present invention, in formation of a coating layer on a drawn optical fiber, troubles including an external abnormality, such as bubble entrainment in the coating layer or unevenness of the coating layer, fiber breakage, decentering, dimensional variability, resin overflow, and the like can be prevented or reduced.

### BRIEF DESCRIPTION OF THE DRAWINGS

FIG. 1 is a diagram of the schematic configuration of an optical fiber manufacturing apparatus used in an optical fiber manufacturing method according to one embodiment of the present invention.

FIG. 2 is a schematic view illustrating measurement of an ejection amount according to one embodiment of the preset invention, which is performed before an optical fiber manufacturing step.

FIG. 3 is a diagram showing a processing procedure of an optical fiber manufacturing method according to one embodiment of the present invention.

FIG. 4 shows relations between a resin pressure and an ejection amount used in an optical fiber manufacturing method according to one embodiment of the present invention.

### DETAILED DESCRIPTION OF THE INVENTION

Embodiments of the present invention are described in detail below with reference to the drawings. Note that, throughout the drawings described below, parts having the same functions are given the same reference numerals, and are not repeatedly described.

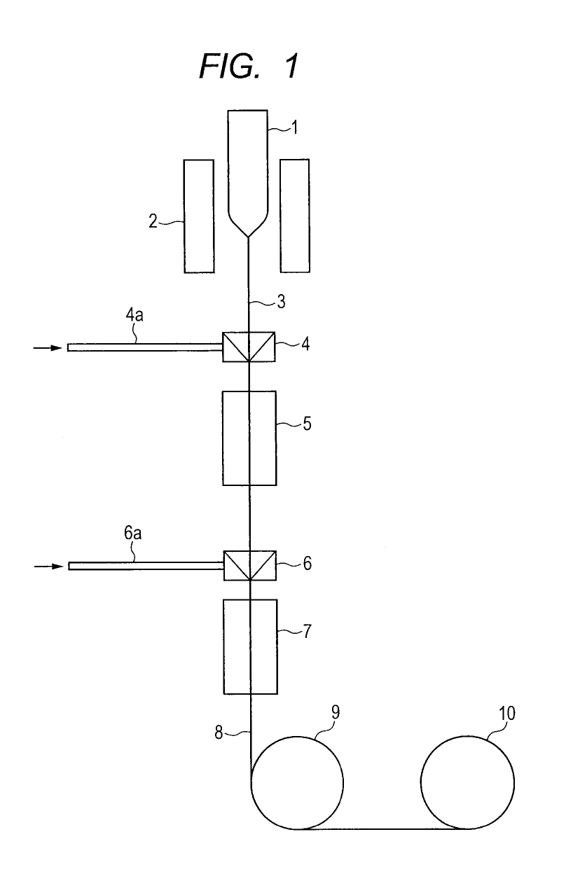

FIG. 1 is a diagram of the schematic configuration of an optical fiber manufacturing apparatus according to one embodiment of the present invention. In FIG. 1, a heater 2 is provided around an optical fiber preform 1, and the optical fiber preform 1 is heated and melted by the heater 2 and is stretched so that an optical fiber 3 having a predetermined diameter is obtained. A coating device 4 and a curing device 5 are provided at a stage after the heater 2 (downstream in the moving direction of the optical fiber 3). The coating device 4 is provided with a resin supply hose 4a configured to supply the coating device 4 with liquid resin from a resin tank (not shown). A detachable coupler is provided to a tip end of the resin supply hose 4a. This detachable coupler enables the resin supply hose 4a to be attached to and detached from the coating device 4, such as a die, so that liquid resin can be supplied to the coating device 4. By passing the optical fiber 3 inside the coating device 4 to which liquid resin is supplied through the resin supply hose 4a, the optical fiber 3 is coated, on its outer surface, with liquid curable resin for primary coating (liquid resin). Further, by causing the optical fiber 3 to pass inside the curing device 5, the liquid resin is cured, so that a primary coating layer is formed on the optical fiber.

A coating device 6 and a curing device 7 are provided at a stage after the curing device 5. The coating device 6, too, is provided with a resin supply hose 6a configured to supply the coating device 6 with liquid resin from a resin tank (not shown). The resin supply hose 6a is also provided with a detachable coupler at its tip end, and this detachable coupler enables the resin supply hose 6a to be attached to and detached from the coating device 6, such as a die, so that liquid resin can be supplied to the coating device 6. By causing the optical fiber 3 having undergone the primary coating to pass inside the coating device 6 and the curing device 7, a secondary coating layer of curable resin for secondary coating (liquid resin) is formed on the primary coating layer. An optical fiber 8 in which the primary and secondary coating layers are thus formed is wound on a winding machine 10 via a capstan 9.

Note that, in the embodiment of the present invention, the curable resin for primary coating and the curable resin for secondary coating may be a resin cured by ultraviolet light (ultraviolet-curable resin) or a resin cured by heat (heat-curable resin). For example, when the curable resin for primary coating is an ultraviolet-curable resin, the coating device 4 applies liquid ultraviolet-curable resin to the optical fiber 3, and the curing device (e.g., a UV lamp) 5 applies ultraviolet light to the optical fiber 3 passing thereinside to cure the curable resin for primary coating on the optical fiber 3. When the curable resin for primary coating is a heat-curable resin, the coating device 4 applies liquid heat-curable resin to the optical fiber 3, and the curing device (e.g., a heater) 5 heats the optical fiber 3 passing thereinside to cure the curable resin for primary coating on the optical fiber 3.

As will be described later, one of the characteristics of the present invention is to judge whether an ejection amount of liquid resin is within an acceptable range or not, before an optical fiber is manufactured by an optical fiber manufacturing apparatus as the one shown in FIG. 1, or at a predetermined timing. This judgment is performed independently of the optical fiber manufacture, by using the configurations for supplying resin to the coating device (e.g., the resin tank and the resin supply hose) employed in the optical fiber manufacturing apparatus.

FIG. 2 is a schematic view illustrating ejection-amount measurement according to one embodiment of the present invention, which is carried out before the optical fiber manufacturing step.

In FIG. 2, reference numeral 21 denotes a support provided separately from the optical fiber manufacturing apparatus. A cup 22 is placed on the support 21. Reference numeral 20 denotes a resin supply mechanism for supplying resin to the coating device of the optical fiber manufacturing apparatus. The resin supply mechanism 20 includes a resin tank 23, a resin supply hose 24, and a filter 25. The resin tank 23 contains liquid resin which is curable resin in liquid form (e.g., the curable resin for primary coating or the curable resin for secondary coating). The resin supply hose 24 is connected to the resin tank 23, and functions as a flow passage through which the liquid resin contained in the resin tank 23 is supplied to the coating device and the cup 22. The liquid resin is supplied from the resin tank 23 to the coating device and the cup 22 through this resin supply hose 24. In one embodiment of the present invention, the filter 25 is provided to a part of the resin supply hose 24, but the position of the filter 25 is not limited to a part of the resin supply hose 24. Further, the filter 25 does not have to be provided.

In one embodiment of the present invention, the resin supply hose 24 is connected to the above-described coating device during the optical fiber manufacture, and is connected to the cup 22 during the measurement of the ejection amount of liquid resin which is performed before starting the optical fiber manufacture.

Note that the support 21 is provided such that a positional relation including the height of the cup 22 placed on the support 21 with respect to the resin supply mechanism 20 and the length of the resin supply hose 24 when the resin supply mechanism 20 is connected to the cup 22 would be the same as a positional relation including the height of the resin supply mechanism 20 with respect to a target coating device (e.g., a die) and the length of the resin supply hose 24 when the resin supply mechanism 20 is connected to the coating device being a connection target of the resin supply mechanism 20.

In one embodiment of the present invention, the configuration for supplying liquid resin from the resin tank 23 to the coating device or to the cup 22 is not particularly limited. Any method with which liquid resin can be ejected from the resin tank 23 to the coating device or the cup 22 may be employed. For example, liquid resin is pressure-fed from the resin tank 23 to the cup 22 by applying pressure to the inside (liquid resin) of the resin tank 23 (also called a “pressure method” below), or liquid resin is supplied from the resin tank 23 to the cup 22 by driving a pump provided to a part of the passage of the resin supply hose 24. Any of these methods may be used, but the configuration for supplying liquid resin from the resin tank 23 to the coating device has to employ the same method as the configuration for supplying liquid resin from the resin tank 23 to the cup 22.

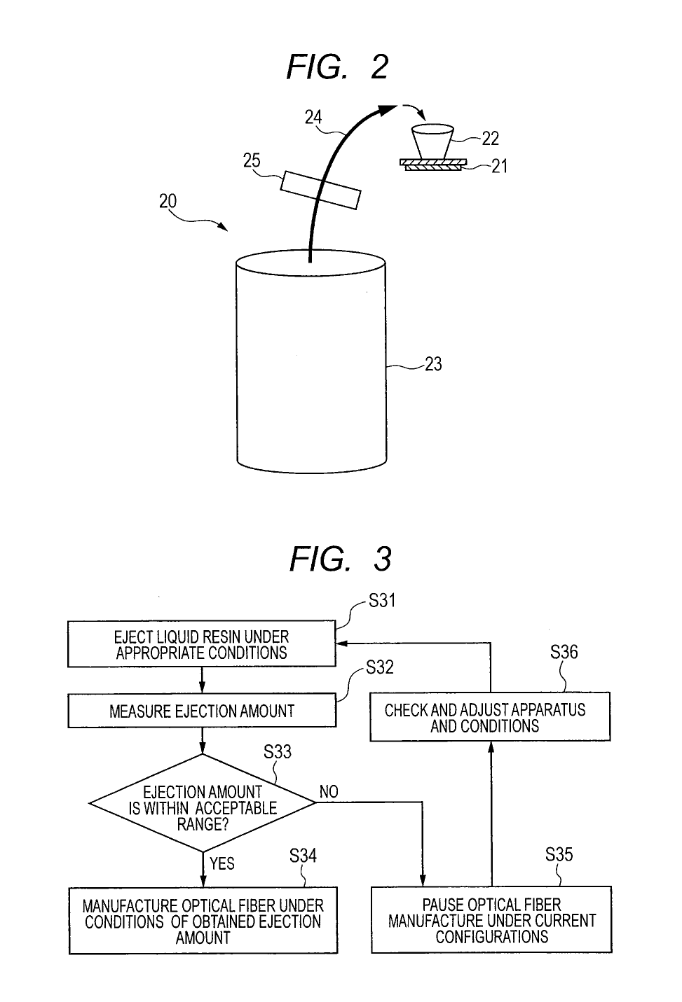

FIG. 3 is a flowchart showing an example of an optical fiber manufacturing method according to one embodiment of the present invention. In FIG. 3, the pressure method is employed for supplying liquid resin, in which a certain pressure is applied to the inside of the resin tank (also called a “resin pressure”), and the ejection-amount measurement carried out before the optical fiber manufacturing step is performed for the curable resin for primary coating. Accordingly, the resin supply hose 4a in FIG. 1 corresponds to the resin supply hose 24, and the liquid resin contained in the resin tank 23 corresponds to the curable resin for primary coating. Hence, the resin supply mechanism 20 is connected to the coating device 4 at the time of optical fiber manufacture, and the support 21 is provided at such a position that the positional relation between the resin supply mechanism 20 and the coating device 4 when the resin supply mechanism 20 is connected to the coating device 4 is the same as the positional relation between the resin supply mechanism 20 and the cup 22 when the resin supply mechanism 20 is connected to the cup 22.

Needless to say, the method shown in FIG. 3 may be performed for the curable resin for secondary coating, and also for a double-layer collective application method in which the curable resin for primary coating layer to be the primary coating layer and the curable resin for secondary coating to be the secondary coating layer may be applied at once using a single coating device and cured.

In FIG. 3, prior to Step S31, conditions (such as the viscosity and temperature of resin) for achieving an appropriate ejection amount suited for the configuration of the manufacturing apparatus and for the composition of resin are predetermined through evaluation of the ejection amount of liquid resin. Such condition determination needs to be performed when changing the configuration of the apparatus, such as using a newly-developed manufacturing apparatus or changing the configuration of the resin supply mechanism, or when introducing a new resin composition. Using the conditions thus determined, it is determined in Steps S31 to S33 whether the manufacturing apparatus has experienced a state change or not. The procedure proceeds to the optical fiber manufacture (Step S34) when the ejection amount is within an appropriate range, and ends the manufacture when it is not within the appropriate range (Step S35).

If the ejection amount of liquid resin is too small, liquid resin supplied to the coating device 4 might run short, possibly leading to entrainment of bubbles in the coating layer formed on the optical fiber. If the ejection amount is too large, the liquid resin overflows from the top part of the coating device 4, possibly leading to unevenness of the coating layer. For these reasons, in one embodiment of the present invention, various conditions are determined to achieve an ejection amount in an appropriate range which is not too small and not too large as well as ejection of liquid resin by such ejection amount.

Then, at a previous stage of an actual optical-fiber manufacturing process, it is determined whether the ejection amount of liquid resin under the various conditions thus determined is within the appropriate range or not, as will be described later.

As an example, the conditions for achieving the appropriate ejection amount and ejection by the appropriate ejection amount are determined as follows as a step preceding the method shown in FIG. 3. First, conditions such as a condition for supplying liquid resin from the resin tank 23 to the cup 22 (e.g., a pressure value if the pressure method is employed), the material of the resin tank 23, the material, length, and caliber of the resin supply hose 24, and the material and caliber of the filter provided to a part of the resin supply hose 24 (these are also collectively called the “configurations of the resin tank 23 and the resin supply hose 24” below) are fixedly determined. Then, the resin supply hose 24 is connected to the cup 22, and liquid resin having certain values of viscosity and temperature is ejected through the resin supply hose 24 to measure the ejection amount of the liquid resin thus ejected. This measurement of the ejection amount can be carried out as follows, for example. The liquid resin is ejected using the fixedly-determined configurations of the resin tank 23 and the resin supply hose 24. Then, an amount of time before a predetermined amount is pooled in the cup 22 is measured. Then, an ejection amount per unit time (e.g., mL/sec) is calculated from the amount of time and the amount of liquid resin pooled in the cup 22 in this amount of time.

Next, the resin supply hose 24 is connected to the coating device 4, and using the fixedly-determined configurations of the resin tank 23 and the resin supply hose 24, a coating layer is formed on an optical fiber with liquid resin having the certain values of viscosity and temperature. Then, this coating layer is observed. For example, if bubble entrainment is found as a result of the observation of the coating layer using a microscope, the ejection amount is less than the appropriate ejection amount. If the optical fiber after the coating is disconnected or if the coating layer has a bump, the ejection amount is greater than the appropriate ejection amount.

If neither bubble entrainment, fiber disconnection, nor bump generation is found as a result of the observation, it is judged that the current conditions satisfy requirements for achieving the appropriate ejection amount of liquid resin, and the current ejection amount is set as an appropriate ejection amount for a certain resin pressure. Further, the current viscosity and temperature of the liquid resin are set as conditions for achieving ejection by the appropriate ejection amount.

On the other hand, if any of bubble entrainment, fiber disconnection, or bump generation is found as a result of the observation, it is judged that the current conditions are not conditions for achieving the appropriate ejection amount of liquid resin. Then, using the fixedly-determined configurations of the resin tank 23 and the resin supply hose 24, at least one of the viscosity and the temperature of the liquid resin is changed, and the measurement is carried out in the same manner as above. Note that when the ejection amount is small, it can be increased by increasing the temperature of the liquid resin or by changing the resin to one with a lower viscosity, and when the ejection amount is large, it can be decreased by decreasing the temperature of the liquid resin or by changing the resin to one with a higher viscosity. The temperature of the liquid resin can be controlled by, for example, providing a heater to the resin tank 23. If neither bubble entrainment, fiber disconnection, nor bump generation is found as a result of the observation after the re-measurement, it is judged that the current conditions are the conditions for achieving the appropriate ejection amount of liquid resin, and the current ejection amount is set as the appropriate ejection amount for the certain resin pressure. Further, the current viscosity and temperature of the liquid resin are set as conditions for achieving ejection by the appropriate ejection amount.

The appropriate ejection amount and the conditions for achieving the appropriate ejection amount obtained as described above may be recorded. By recording them, as long as the fixedly-determined configurations of the resin tank 23 and the resin supply hose 24 are used, the liquid resin can be ejected by the appropriate ejection amount if the liquid resin is ejected using the recorded conditions. Further, when an apparatus of a similar configuration or a resin having a similar composition is used, making reference to the recorded conditions facilitates determination of conditions for achieving an appropriate ejection amount or ejection by the appropriate ejection amount.

The appropriate ejection may not only be a certain value, but also have a certain range. Accordingly, when a certain value of an ejection amount with which no bubble entrainment, fiber disconnection, or bump generation is found by the measurement is obtained, at least one of the viscosity or the temperature of the liquid resin is changed, while changing the resin pressure, to change the ejection amount. Then, an optical fiber is actually coated using each of the ejection amounts thus changed and is observed. Thus, multiple ejection amounts with which no bubble entrainment, fiber disconnection, or bump generation is found may be obtained to gain a range of ejection amounts with which an appropriate ejection is achievable.

In the embodiment described above, at least one of the viscosity and the temperature of the liquid resin is changed to change the ejection amount when any of bubble entrainment, fiber disconnection, or bump generation is found. Instead, the ejection amount of liquid resin may be controlled, not by changing the viscosity or the temperature of the liquid resin, but by changing at least one of elements of the configurations of the resin tank 23 and the resin supply hose 24 (e.g., changing the material of the resin supply hose 24).

By applying a predetermined resin pressure to liquid resin contained in the resin tank 23, the liquid resin is ejected from the resin tank 23 to the cup 22. When the pressure method is employed, in the above-described conditions, it is preferable that relation between resin pressure x (kg/cm²) which is a pressure to be applied to the liquid resin and ejection amount y (mL/sec) of the liquid resin should satisfy the following formula.

[Formula 1]

1.3\sqrt{x}≦y≦4\sqrt{x} Formula (1)

Satisfying Formula (1) offers an advantage that bubble entrainment, fiber disconnection, and bump generation are unlikely to occur.

When the temperature of a resin of a certain viscosity is set to a certain value using a given filter and hose, the ejection amount is proportional to the square root of the resin pressure, according to a theoretical relational equation of the pressure and the flow rate of liquid. In accordance with this relation, the lower and upper limit equations of Formula (1) are correction coefficients obtained as a result of variously changing the conditions for achieving the appropriate ejection amount, which is done before Step S31 mentioned above, and Formula (1) is not affected by facility configurations and the like.

Further, the pressure applied to the liquid resin (resin pressure) is preferably 1 to 5 kg/cm² in consideration of the pressure-resisting features of the facility, such as the resin tank and the resin supply hose. When an ultraviolet-curable urethane acrylate resin is used as the liquid resin, the temperature of the liquid resin (resin temperature) during the manufacture is preferably 40° C. to 50° C. This is because, on one hand, a resin is hard to control when its temperature is near the room temperature, and on the other hand, volatilization, polymerization, or the like is concerned when the temperature is as high as 60° C. Moreover, a preferable viscosity of the liquid resin (resin viscosity) is 1000 to 5000 mPa·s when the resin temperature is 40° C. and is 500 to 3000 mPa·s when the resin temperature is 50° C. This is for achieving favorable manufacturability (applicability), including an appropriate amount of ejection time (an ejection amount), with the above-described resin temperatures.

In Step S31, prior to the optical fiber manufacturing step (Step S34), liquid resin is ejected from the resin tank 23 to the cup 22 by the appropriate ejection amount obtained in advance. More specifically, the resin supply hose 24 is connected to the cup 22, and liquid resin is ejected into the cup 22 under the conditions (e.g., the temperature and viscosity of the liquid resin) for achieving ejection by the appropriate ejection amount of the certain resin pressure, using the fixedly-determined configurations of the resin tank 23 and the resin supply hose 24.

In Step S32, the ejection amount of the liquid resin ejected in Step S31 is measured. The ejection amount can be measured as described above. Specifically, for example, an amount of time which it takes for the liquid resin ejected through the resin supply hose 24 to pool the predetermined amount of the liquid resin in the cup 22 is measured. Then, an ejection amount per unit time (e.g., mL/sec) is calculated from the amount of time and the amount of the liquid resin pooled in the cup 22 in this amount of time.

In Step S33, it is determined whether the ejection amount measured in Step S32 is within an acceptable range or not. The procedure proceeds to Step S34 if the ejection amount is within the acceptable range, and to Step S35 if the ejection amount is not within the acceptable range. In these steps, by applying a certain resin pressure to the liquid resin contained in the resin tank 23, the liquid resin is ejected from the resin tank 23 to the cup 22. Then, it is judged that the ejection amount measured in Step S32 is within the acceptable range when the relation between resin pressure x (kg/cm²) which is a pressure applied to the liquid resin and ejection amount y of the liquid resin (mL/sec) satisfies Formula (1) described above, whereas it is judged that the ejection amount is not within the acceptable range when the relation does not satisfy Formula (1).

When it is determined in Step S33 that the liquid resin can be ejected by the appropriate ejection amount which can prevent or reduce bubble entrainment, fiber disconnection, or bump generation using the current configurations of the resin tank 23 and the resin supply hose 24, in Step S34 an actual optical fiber coating step is performed under the conditions (the viscosity and temperature of the liquid resin) for achieving ejection by the appropriate ejection amount used in Step S31. In this step, the resin supply hose 24 is connected to the coating device 4.

When it is determined in Step S33 that the liquid resin cannot be ejected by the appropriate ejection amount using the current configurations of the resin tank 23 and the resin supply hose 24, in Step S35 the optical fiber manufacturing step is not performed using the current configurations of the resin tank 23 and the resin supply hose 24, and is stopped.

Generally, when the configurations of the resin tank 23 and the resin supply hose 24 are fixedly determined, and the temperature and viscosity of liquid resin and the resin pressure are set to the predetermined values, the liquid resin should be ejected with a fixed ejection amount. However, in some cases, the ejection amount of liquid resin departs from the designed value when a state change occurs in any of the elements of the configurations of the resin tank 23 and the resin supply hose 24, the state change including, for example, clogging of the filter 25 or the resin supply hose 24, deterioration of the heater for heating the resin tank 23, and the like. The filter 25 and the resin supply hose 24 are clogged when, for example, a slight difference in the compositional blending quantity or physical property of the liquid resin causes the liquid resin to suffer a slight reaction by being kept at a resin temperature for the manufacture and thereby to produce a foreign matter. If the departing ejection amount is still within the acceptable range, the coating can be performed while suppressing bubble entrainment, fiber disconnection, and bump generation. However, if the departing ejection amount is out of the acceptable range of ejection amount, i.e., out of a range of the appropriate ejection amount, the ejection amount of liquid resin is either too small or too large, which might lead to generation of an external abnormality such as bubble entrainment or uneven coating. That is, even when the property of resin are limited or when the manufacturing conditions or the configurations of a facility or an apparatus are modified to prevent bubble entrainment and uneven coating as in the conventional techniques, a state change in an element of the configurations of the resin tank 23 and the resin supply hose 24 might cause bubble entrainment and uneven coating.

To cope with this, in one embodiment of the present invention, the ejection amount of liquid resin ejected into the cup 22 is focused on, and as a step preceding the actual optical fiber manufacturing step, the resin supply mechanism used in the actual optical fiber manufacturing step is used to measure whether the ejection amount of liquid resin is an appropriate value or not. This ejection amount reflects the states of the elements of the configurations of the resin tank 23 and the resin supply hose 24, as described above. Accordingly, by judging whether the ejection amount with certain configurations is appropriate or not, it can be indirectly judged whether the configurations have a state change which is beyond the acceptable range. Consequently, in one embodiment of the present invention, unlike the conventional techniques, the ejection conditions of liquid resin are managed before the actual optical fiber manufacture. Thereby, an external abnormality such as uneven coating or bubble entrainment can be prevented from occurring.

Further, in one embodiment of the present invention, since the coating device can be supplied with the appropriate amount of liquid resin in the actual optical fiber manufacture, the optical fiber can be stably coated with the resin in the longitudinal direction of the optical fiber, allowing reduction in generation of a coating fault (such as a lump or a bump), and deformation between the coating layers (such as a crease, a scratch, or a bubble). Further, the decentering is less likely to occur, and dimensional variability and overflow of resin can be reduced.

Note that when the optical fiber manufacturing step is stopped in Step S35, a state change which is beyond the acceptable range is likely to be occurring in any of the elements of the configurations of the resin tank 23 and the resin supply hose 24, as described above. Accordingly, Step S36 for checking and adjusting the apparatus and conditions such as set values may be performed after Step S35. In Step S36, for example, each of the elements of the configurations of the resin tank 23 and the resin supply hose 24 is checked in order to find out in which element the state change is occurring. Then, if it is found out, as a result of the check, that the resin supply hose 24 or the filer 25 is clogged, the resin supply hose 24 or the filer 25 is cleaned. If the heater for heating the resin tank 23 is experiencing operational failure, the heater is replaced. After handling and solving the state change, Steps S31 to S33 are repeated. In this way, the factor of bubble entrainment or uneven coating can be excluded before the actual optical fiber manufacturing step.

Further, in Step S36, the ejection amount may be changed by changing at least one of the viscosity and temperature of the liquid resin, so that the ejection amount of liquid resin may be adjusted to fall within the appropriate range.

### Example and Comparative Example

In an example and a comparative example, the pressure method was used as the method for supplying liquid resin from the resin tank 23 to the cup 22.

Further, in the example and the comparative example, the material of the resin supply hose 24 is nylon, and the material of the resin filter 25 is polypropylene, but the materials are not limited to these.

Table 1 shows a resin pressure, a resin viscosity, a resin temperature, and an ejection amount (mL/sec) of liquid resin in the example and the comparative example. In the example and the comparative example, under the conditions shown in Table 1, a primary coating layer was formed on an optical fiber by applying liquid resin to the optical fiber and curing the applied liquid resin by ultraviolet irradiation.

Although the primary coating layer is formed on the optical fiber as an instance in this example, the present invention may be employed for formation of the secondary coating layer. In this case, the support 21 and the cup 22 which correspond to the coating device 6 are prepared, and Steps S31 to S33 in FIG. 3 are performed before the optical fiber manufacturing step, using the resin supply mechanism connected to the coating device 6. It goes without saying that the present invention is also applicable to a case where the primary coating layer and the secondary coating layer are formed collectively. In this case, the apparatus has only one of the coating devices 4 and 6, and the support 21 and the cup 22 which correspond to the coating device 4 or 6 are prepared. Then, Steps S31 to S33 in FIG. 3 are performed before the optical fiber manufacturing step, using the resin supply mechanism connected to the coating device 4 or 6.

TABLE 1

| | Resin | | | | Ejection | |
|---|---|---|---|---|---|---|
| | pressure | Viscosity | Temperature | | amount | Coating |
| | (kg/cm²) | (mPa · s) | (° C.) | Judgment | (mL/sec) | failure |
| Example | 2.8 | 1200 | 40 | Within range | 2.7 | None |
| | 1.5 | 800 | 50 | Within range | 2.2 | None |
| | 2.9 | 800 | 50 | Within range | 4.3 | None |
| | 2 | 700 | 50 | Within range | 4.0 | None |
| | 2.9 | 700 | 50 | Within range | 6.7 | None |
| | 2.5 | 1300 | 40 | Within range | 2.2 | None |
| | 1.7 | 700 | 50 | Within range | 4.5 | None |
| Comparative | 2.7 | 2400 | 40 | Outside | 1.7 | Bubble |
| example | | | | range | | entrainment |
| | 2 | 2700 | 30 | Outside | 1.4 | Bubble |
| | | | | range | | entrainment |
| | 2 | 500 | 50 | Outside | 6.7 | Resin |
| | | | | range | | overflow |

### Concerning Criterion for Judgment of Failure in this Example

Existence of bubble entrainment is judged by observing, with a microscope, the inside of the coating layer, the interface between glass (optical fiber) and the coating fiber, or the interface between the coating layers. The resin overflow is discovered when a coated optical fiber is disconnected or when a bump is found by an external observation of a product. In either case, the criterion for judgment is whether or not the failure occurs within a given drawing length (about 100,000 km).

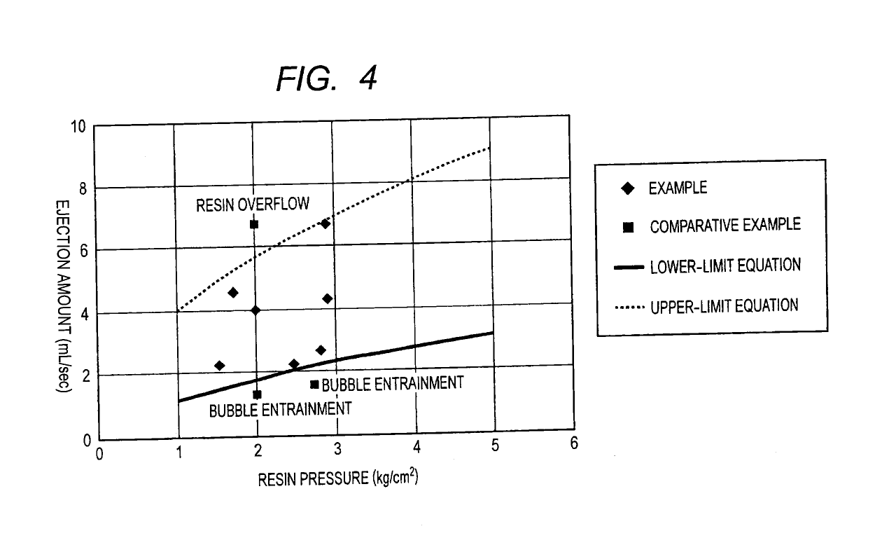

FIG. 4 is a diagram showing relations between a resin pressure and an ejection amount in the example and the comparative example shown in Table 1. An upper-limit equation and a lower-limit equation in FIG. 4 are the upper-limit equation and the lower-limit equation of Formula (1), which are as follows.

Upper-limit Equation: y=4\sqrt{x}

Lower-limit Equation: y=1.3\sqrt{x} [Formula 2]

As shown in FIG. 4, when the relation of Formula (1) is satisfied, both of bubble entrainment and resin overflow can be prevented or reduced. In other words, in the pressure method, with resin pressure x being fixed, ejection amount y which satisfies Formula (1) with respect to resin pressure x is in a range of an appropriate ejection amount.

In table 1, using the fixed configurations of the resin tank 23 and the resin supply hose 24, the ejection amount is changed by changing at least one of the temperature and the viscosity of the liquid resin with the resin pressure being fixed. However, as described above, even if the temperature or the viscosity of the liquid resin is not changed, the ejection amount still changes due to a failure of an element of the configurations of the resin tank 23 and the resin supply hose 24. Accordingly, each of the relations in FIG. 4 shows a relation between the resin pressure and the amount of liquid resin ejected from the outlet of the resin supply hose 24 into the cup 22, irrespective of whether a change in the ejection amount is because of a change in the temperature or viscosity of the liquid resin or because of a failure of any element of the above-described configurations. For this reason, even when the ejection amount changes because of a failure of the element with a given resin pressure and a given temperature and viscosity of liquid resin, the changed ejection amount is within an acceptable range as long as the ejection amount satisfies Formula (1) with respect to resin pressure x.

Consequently, when liquid resin is ejected using a fixed pressure applied to the liquid resin in the resin tank 23 (a resin pressure), the effects described above can be obtained regardless of the types of the resin tank 23 and the filter 25, the length, configuration, or layout of the resin supply hose 24, and the like, as long as the ejection amount of liquid resin is within the range of Formula (1). Thus, it is determined in Step S33 in FIG. 3 whether or not the ejection amount of liquid resin measured in Step S32 satisfies Formula (1) with respect to fixed pressure x applied in Step S31. When the ejection amount satisfies Formula (1), the procedure proceeds to Step S34 to perform the actual optical fiber manufacturing step. On the other hand, when the ejection amount does not satisfy Formula (1), the procedure proceeds to Step S35 to pause the optical fiber manufacturing step. As a result, bubble entrainment in the coat or uneven coating can be prevented.

What is claimed is:

1. An optical fiber manufacturing method including a step of supplying liquid resin from a container configured to contain the liquid resin to a coating device by ejecting the liquid resin to the coating device through a supply passage connected to the container, and causing the coating device to apply the liquid resin to an optical fiber to form a coating layer on the optical fiber, comprising the steps of:
causing, before the step of forming the coating layer, the liquid resin to be ejected through the supply passage to a vessel which is separate from the coating device, to measure an ejection amount of the liquid resin; and
determining whether the measured ejection amount of the liquid resin is within an acceptable range or not, and wherein
the step of forming the coating layer is performed when it is determined that the measured ejection amount of the liquid resin is within the acceptable range.

2. The optical fiber manufacturing method according to claim 1, wherein
the ejection of the liquid resin is performed by applying a certain pressure to an inside of the container, and
it is determined in the determining step that the measured ejection amount of the liquid resin is within the acceptable range when the measured ejection amount of the liquid resin satisfies:
1.3\sqrt{x}≦y≦4\sqrt{x}, [Formula 3]
where x is the certain pressure (kg/cm²), and y is the ejection amount of the liquid resin (mL/sec).

3. The optical fiber manufacturing method according to claim 1, wherein
when the measured ejection amount of the liquid resin is not within the acceptable range, the step of forming the coating layer is paused and a condition check step is performed, and
after the condition check step, a step of re-measuring the ejection amount of the liquid resin is performed.
